(19) United States
(12) Patent Application Publication
(10) Pub. No.: US 2009/0182489 A1
(43) Pub. Date: Jul. 16, 2009

(54) INTAKE AIR TEMPERATURE (IAT) RATIONALITY DIAGNOSTIC WITH AN ENGINE BLOCK HEATER

(76) Inventors: Koon Chul Yang, Pittsford, NY (US); Timothy K. Sheffer, Rush, NY (US)

Correspondence Address: DELPHI TECHNOLOGIES, INC., M/C 480-410-202, PO BOX 5052, TROY, MI, 48007, US

(21) Appl. No.: 12/015,030

(22) Filed: Jan. 16, 2008

(51) Int. Cl. F02D 35/00

(52) U.S. Cl. 701/113

(57) ABSTRACT

A first method is suitable for vehicles having an ambient temperature sensor and employs an estimation model configured to estimate a minimum start-up engine coolant temperature (SUECT) if the engine block heater was operated during the previous soak period. A measured SUECT is then compared to estimated minimum SUECT from the model, and if it is higher, then the diagnostic logic concludes that the engine block heater was operated during the soak period, and disables the reporting its test results. A second method is suitable for vehicles without an ambient (soak) temperature sensor employs an alternative approach. Predetermined data based on actual vehicle testing over a wide range of conditions is stored in a data structure. The data describe respective minimum and maximum start-up IAT thresholds versus SUECT. The thresholds are spaced apart to define a start-up IAT window in between. In other words, the window is bounded by minimum and maximum start-up IAT thresholds. For any measured SUECT, a particular window will be set. If the measured start-up IAT falls within the window, then the engine block heater was operated during the soak period.

### TECHNICAL FIELD

The invention relates generally to vehicle diagnostics and more particularly to a method of checking the rationality of an intake air temperature (IAT) reading for engine configurations having an engine block heater.

### BACKGROUND OF THE INVENTION

Increasing awareness of the effects of vehicle exhaust emissions and the like has resulted in regulations to control these emissions. In particular, various federal and state on-board diagnostic regulations (e.g., OBDII) require that certain emission related systems on the vehicle be monitored, and that a vehicle operator be notified if the system is not functioning in a predetermined manner. Automotive vehicle electronics therefore include a programmed diagnostic data manager or the like service configured to receive reports from diagnostic algorithms/circuits concerning the operational status of various components or systems and to set/reset various standardized diagnostic trouble codes (DTC) and/or otherwise generate an alert (e.g., MIL). The intent of such diagnostics is to inform the operator when performance of a component and/or system has degraded to a level where emissions performance may be affected and to provide information (e.g., via the DTC) to facilitate remediation.

A number of engine control and diagnostic algorithms use and/or rely on an intake air temperature (IAT) measurement. In view of the fact that an IAT measurement that is erroneous and/or faulty in some regard may have an impact on emissions, it is accordingly known to perform various diagnostics on the IAT sensor/circuit/output, including what is referred to as an IAT rationality test to verify that the IAT measurement is rational (i.e., sensible to rely on). One characteristic evaluated is whether the measured IAT is skewed relative to what it should be (i.e., skewed high or skewed low), for example, as seen by reference to U.S. Pat. No. 7,120,535 entitled “METHOD AND APPARATUS TO EVALUATE AN INTAKE AIR TEMPERATURE MONITORING CIRCUIT” issued to Rahman et al, owned by the common assignee of the invention and hereby incorporated by reference in its entirety.

Rahman et al. disclose a method for performing an IAT (skew low) rationality test that involves comparing the IAT measurement with an engine coolant temperature (ECT) measurement under circumstances where they are expected to be about the same. For example, start-up IAT and ECT measurements should generally be the same after a long (e.g., greater than 6 hours) “soak” in cold environments (i.e., when a vehicle is exposed to ambient air temperatures, with its ignition turned off and thus has been allowed to cool off). If there is a large temperature offset (e.g., >20° C.) between the start-up IAT and ECT after adequate soak time, the IAT rationality test assumes that the IAT sensor output signal is skewed, and then conducts a secondary drift check. The purpose of the secondary check is to determine if the large temperature offset is caused by a skewed sensor (which should fail the test) or rather by non-stabilized ambient conditions (which should not fail the test). Rahman et al further disclose that the secondary check involves subsequent monitoring of the IAT sensor output for a predetermined amount of time, constantly comparing new IAT readings with the start-up IAT. If the subsequent IAT reading(s) do not show sufficient change within the predetermined time, the IAT rationality test will conclude that the IAT sensor/output is skewed and a failure will be reported. However, if there is sufficient change in the IAT, no report is made, on the belief that unstable ambient conditions caused the initial skew between the start-up IAT and start-up ECT. When certain conditions are met (e.g., a recurrence of the detected IAT skew), a failure code or other indication may be generated (i.e., a DTC “P0111—IAT Circuit Range/Performance Problem” flag may be set).

A problem, however, exists in the art. In this regard, it is known to provide an engine block heater on certain vehicles, which is a desirable feature especially in colder climates. The engine block heater is typically deployed as a heating element or the like located in the engine block. During cold weather conditions, the engine block heater is operated, typically from an external alternating current (AC) power source, for heating the engine block and thus also heating up the engine coolant. This facilitates cold starting, among other benefits. Operation of the engine block heater, however, can confuse the IAT diagnostics logic described above. Testing has shown that the engine block heater can (1) raise the engine coolant temperature (ECT) as much as 50° C. above ambient and (2) raise the intake air temperature (IAT) as much as 20° C. above ambient. This results in a temperature offset at start-up between IAT and ECT by as much as 35° C. after an ample soak time. The IAT rationality test described above, in the face of this data, concludes that there is a rationality problem with the IAT sensor output since it is skewed to the low side of the ECT. This conclusion, however, is erroneous. Moreover, since the engine block heater is operated from externally-provided AC power, it is not possible for an engine control unit (ECU) or the like to directly detect if an engine block heater was operated during soak. It is important for the reliability of an IAT rationality test to be able to determine if an engine block heater has been used during soak.

There is therefore a need for a method and system for checking the rationality of an intake air temperature (IAT) measurement for engine configurations having an engine block heater that minimizes or eliminates one or more of the problems set forth above.

### SUMMARY OF THE INVENTION

An advantage of one aspect of the invention (i.e., the engine block heater detection logic aspect) is that it provides a mechanism for detecting whether an engine block heater has been operated during the preceding soak period. This knowledge may be used to perform subsequent diagnostics, such as an IAT rationality (skew low) test or an ECT rationality (skew) test. Another advantage, in a second aspect of the invention (i.e., the particular use of the block heater detection logic in an IAT rationality test) is that it reduces or eliminates false failures that might otherwise occur. Various methods, performed during engine start-up, to discern if an engine block heater was operated during the previous cold weather soak are disclosed. If a diagnostic test (e.g., IAT skew) determines that the engine block heater was operated during soak, then the results of any such diagnostic will be ignored (e.g., not reported), preventing an erroneous indication that there is a rationality problem.

For detecting block heater operation during the soak period, two embodiments are provided, one for vehicles having an ambient temperature sensor and one for vehicles without. In the first embodiment, an engine coolant temperature (ECT) model is used to estimate the minimum engine coolant temperature at start-up if the block heater had been operated during the soak period. The first step involves verifying that boundary conditions for use of an ECT estimation model are satisfied. The next step involves estimating a minimum engine coolant temperature (ECT) at a start-up time in accordance with the ECT estimation model. Use of the model includes, among other things, the ambient temperature, both as the beginning of the soak period and at the end of the soak period (i.e., at start-up). The final step involves determining whether the engine block heater was operated during the soak period based on a comparison of the start-up ECT and the estimated minimum ECT from the model. In particular, the method concludes that the engine block heater was operated during the soak period when the measured start-up engine coolant temperature (SUECT) is greater than the estimated minimum start-up ECT from the model.

In the second embodiment of the block heater logic, a windowing approach is used. The first step involves verifying that predetermined predicate conditions based on a start-up engine coolant temperature (SUECT) and a start-up intake air temperature (SUIAT) are satisfied. This check will ensure that outcome can be relied upon. The SUECT and SUIAT are readings taken after the soak period upon the start-up of the engine. The next step involves determining respective minimum and maximum SUIAT thresholds using predetermined SUIAT data as a function of the SUECT. The predetermined SUIAT data is taken for a specific vehicle type over a wide range of conditions. The range between the minimum and maximum SUIAT thresholds define a “window” that is used in a subsequent comparison. The final step involves determining whether the engine block heater was operated during the soak period based on a comparison of the SUIAT and the minimum and maximum SUIAT thresholds (i.e., whether the measured SUIAT is within the “window” defined by the SUIAT thresholds). If the SUIAT is in the “window” then the method concludes that the block heater was used during the soak period.

In another aspect of the invention, the block heater operation detection logic can be usefully applied to various diagnostic tests, including an IAT rationality (skew low) test. In this regard, a method is provided for conducting an intake air temperature (IAT) rationality test in a vehicle with an engine having an engine block heater. The method includes a number of steps. The first step involves determining that vehicle soak conditions meet predetermined criteria for the test, including a duration of the soak period, and commencing the test at a start-up time (i.e., after the soak period). The next step involves determining whether the engine block heater was operated during the soak period. This step may be performed using either of the approaches described above (the first requiring an ambient temperature sensor). Finally, the last step involves discontinuing the rationality test when the engine block heater has been determined to have been operated during the soak period. Therefore, no results generated or that would be generated by the rationality test, such as a pass or a fail indication, are reported (e.g., to a diagnostic data manager), is thereby preventing the erroneous reporting of an IAT rationality test failure.

In one embodiment where the vehicle is configured to include an ambient (soak) temperature sensor, the step of determining whether an engine block heater was operated during the soak period includes a number of substeps. The first step involves verifying that certain boundary conditions for use of an engine coolant temperature (ECT) estimation model have been satisfied. The ECT estimation model describes the thermal interaction of the engine block/coolant with its environment and provides an estimate of the minimum engine coolant temperature if an engine block heater was operated during the soak period. The ECT model makes use of the ambient temperature and the engine coolant temperature previously stored from the last “ignition off” (i.e., around the beginning of the soak period). The ECT model further uses the duration (time) of the soak period and the ambient temperature measured at start-up to determine. With this, the next step involves using the ECT model to estimate the minimum engine coolant temperature (ECT) at start-up. The final step involves determining that the engine block heater was operated during the soak period when the start-up ECT exceeds the minimum estimated ECT from the model.

In a second embodiment where the vehicle, as configured, does not have an ambient (soak) temperature sensor, the step of determining whether an engine block heater was operated during the soak period involves an alternate approach involving windowing. The first step of the method involves verifying that certain predicate conditions are satisfied. These conditions include: (1) the temperature difference between the start-up ECT and IAT being greater than a first temperature threshold (e.g., >20° C.) corresponding to a minimum IAT skew level; (2) the start-up ECT (SUECT) being in a range between second and third temperature thresholds (e.g., between −10° C. and 40° C.); and (3) the start-up IAT being less than a fourth temperature threshold (e.g., <0° C.). The next step involves determining respective minimum and maximum start-up IAT (SUIAT) thresholds using predetermined SUIAT data as a function of the measured SUECT. This minimum and maximum SUIAT thresholds define a window. The final step involves determining that the engine block heater was operated during the soak period when the SUIAT is between the minimum and maximum SUIAT thresholds.

Corresponding systems are also presented.

Other features, aspects and advantages of the invention will become apparent from the detailed description along with the accompanying drawings.

### BRIEF DESCRIPTION OF THE DRAWINGS

The invention will now be described by way of example, with reference to the accompanying drawings:

FIG. 1 is a block diagram of an exemplary automotive vehicle environment, including an engine having an engine block heater, in which embodiments of the invention may be used.

FIG. 2 is simplified flowchart showing the method of the invention.

FIG. 3 is a block diagram of a minimum engine coolant temperature (ECT) model used in a first embodiment of the invention.

FIGS. 4A-4B are charts showing vehicle engine coolant temperature data for different wind speed conditions.

FIG. 5 is a simplified flowchart showing, for the first embodiment, a method of determining whether the engine block heater was operated during the soak period, using the minimum start-up ECT model of FIG. 3.

FIG. 6 is a simplified chart showing start-up IAT data as a function of start-up ECT data, particularly illustrating minimum and maximum start-up IAT thresholds.

FIG. 7 is a simplified flowchart showing, for a second embodiment, a method of determining whether the engine block heater was operated during the soak period, using the minimum and maximum start-up IAT thresholds.

### DETAILED DESCRIPTION OF THE PREFERRED EMBODIMENT

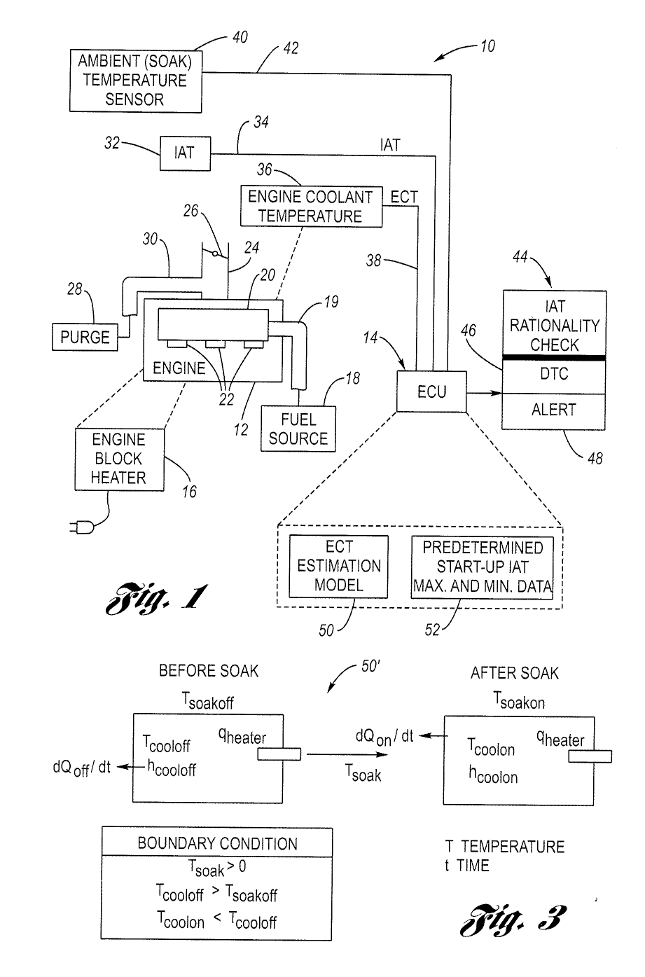

Referring now to the drawings wherein like reference numerals are used to identify identical components in the various views, referring to FIG. 1, the reference numeral 10 generally designates a portion of an exemplary automotive vehicle system 10 in which the inventive intake air temperature (IAT) rationality test may be implemented. The system 10 include an internal combustion engine 12 controlled generally by an electronic engine controller/control unit (ECU) 14 or the like.

Before proceeding to a detailed description, it should be noted that one aspect of the invention provides for multiple approaches to determine whether or not an engine block heater was operated during the previous soak period. This knowledge may be usefully applied to subsequently perform any one or more of a plurality of diagnostic tests, such as an IAT rationality (skew low) test, an ECT rationality (skew) test or other diagnostics now known or hereafter developed that can use the knowledge of whether or not the block heater was operated during soak. Thus, while the illustrated embodiments are directed to an IAT rationality (skew low) diagnostic test, it should be understood that the invention is not so limited.

With continued reference to FIG. 1, the ECU 14 includes at least one microprocessor or other processing unit, associated memory devices such as read only memory (ROM) and random access memory (RAM), a timing clock, input devices for monitoring input from external analog and digital devices and controlling output devices. In general, the ECU 14 is operable to monitor engine operating conditions and other inputs (e.g., operator inputs) using the plurality of sensors and input mechanisms, and control engine operations with the plurality of output systems and actuators, using pre-established algorithms and calibrations that integrate information from monitored conditions and inputs. The software algorithms and calibrations which are executed in the ECU 14 may generally comprise conventional strategies known to those of ordinary skill in the art. Overall, in response to the various inputs, the ECU 14 develops the necessary outputs to control the throttle valve position, fuel, spark, and other aspects, all as known in the art.

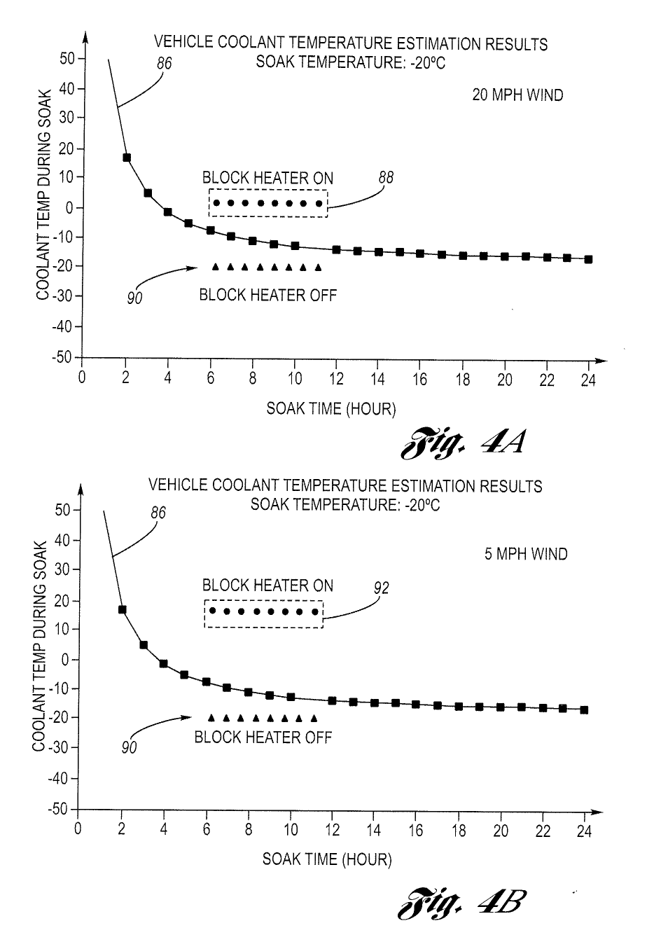

The engine 12 includes an engine block heater 16, which as shown, is configured to be operated by way of connection to an external alternating current (AC) power source or the like by a conventional plug. The engine block heater 16 comprises a heating element(s) disposed in specially-formed bores in the engine block (not shown). The engine block heater 16 is configured to heat the engine block, and thus also the engine coolant of the engine 12, which is especially desirable in colder climates. The engine block heater 16 is configured to deliver heat at a known rate to the engine block, which may be used, for example in the thermal dynamic model of FIG. 3 (more below). It should be appreciated that operation of the engine block heater 16, for example by plugging it into an AC outlet, is not an action under the control of the ECU 14 and thus there is no direct way for the ECU 14 to know that the engine block heater is or has been operated. According to the invention, however, alternate methods are provided for inferring when the engine block heater 16 was operated during the soak period, and incorporating this intelligence into its diagnostic processing.

The engine 12 as known consumes fuel from a fuel source 18 provided via line 19 to an engine fuel rail 20. The fuel may be delivered via a conventional arrangement of a plurality of fuel injectors 22. FIG. 1 further shows an air intake manifold 24 on the vacuum or downstream side of a throttle valve 26 for delivering air to be mixed with fuel, as known. An evaporative emissions control system, shown generally as block 28, may also be included. Evaporative emissions control and diagnostics generally call for an evaporative (“evap”) emissions canister (not shown) be provided in an automotive vehicle. The evap canister is coupled to a fuel tank (not shown) as well as to one or more inlets (e.g., to intake manifold 24 via line 30) by a combination of vent, purge and check valves, suitable connections, etc., all as known in the art. The evaporative emissions system may be of conventional construction and operation.

FIG. 1 also shows a variety of sensors deployed with respect to the engine 12, including an intake air temperature (IAT) sensor 32 configured to generate an IAT signal 34, an engine coolant temperature (ECT) sensor 36 configured to generate an ECT signal 38, and optionally an ambient (soak) temperature sensor 40 configured to generate an ambient temperature signal 42. The IAT signal 34 is indicative of the measured temperature of the intake air. The ECT signal 38 is indicative of the engine coolant temperature. The ambient temperature signal 42 is indicative of the temperature of the environment external to the vehicle. These sensors and their functioning are all well known and understood in the art. For purposes of the invention, these sensors may all comprise conventional components. It should be understood that numerous other sensors typically found in a vehicle/engine system have been omitted for clarity.

In addition to the control of engine 12, the ECU 14 is configured to perform various diagnostics, including an IAT rationality test, shown in block form in FIG. 1 and identified by reference numeral 44. The ECU 14 may be configured to include a diagnostic data manager or the like, a higher level service arranged to manage the reports received from various lower level diagnostic routines/circuits, such as the IAT rationality diagnostic 44, and set or reset diagnostic trouble code(s)/service codes, as well as activate or extinguish various alerts, all as known generally in the art. For example only, such a diagnostic data manager may be pre-configured such that certain non-continuous monitoring diagnostics (e.g., such as the IAT rationality diagnostic) require that such diagnostic fail twice before a diagnostic trouble code (DTC) is set and a malfunction indicator lamp (MIL) is illuminated. As shown in FIG. 1, the ECU is thus configured to set a corresponding diagnostic trouble code (DTC) 46 and/or generate an operator alert 48, such an illumination of a MIL.

Although not shown, in one embodiment, the ECU 14 is configured so as to allow interrogation (e.g., by a skilled technician) for retrieval of such set DTCs. Generally, the process of storing diagnostic trouble codes and subsequent interrogation and retrieval is well known to one skilled in the art. When the invention determines that the engine block heater was operated during the previous soak, IAT rationality test results are not reported to the diagnostic data manager, and accordingly, test failures not indicative of a true IAT rationality problem do not accrue toward the necessary two incidences. Of course, other responses are possible, and known to those of ordinary skill in the art.

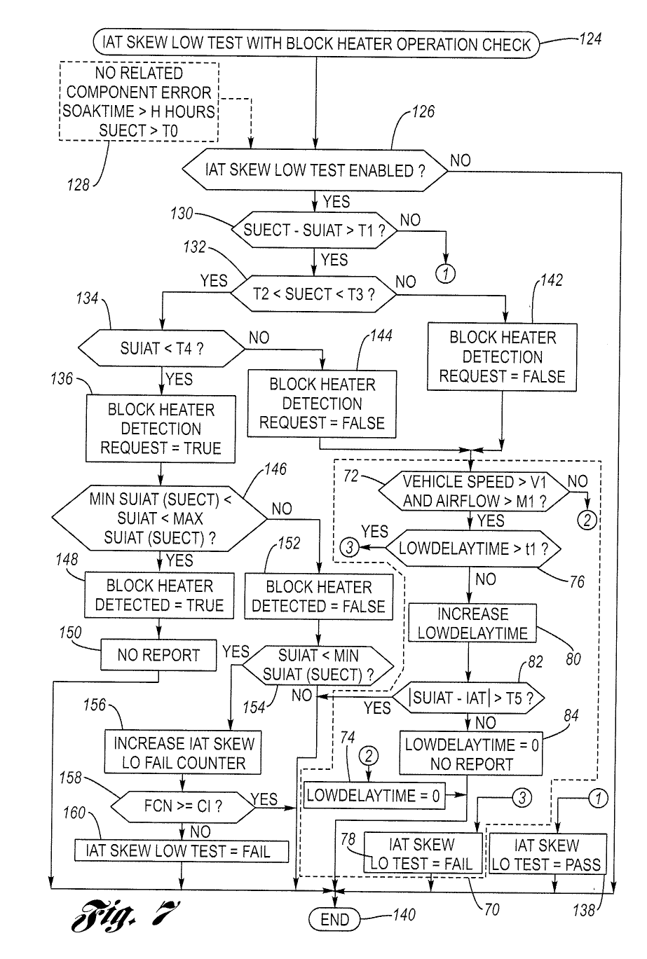

FIG. 1 further shows a minimum engine coolant temperature (ECT) estimation model 50 and a block 52 for predetermined start-up IAT maximum and minimum threshold data. The ECT estimation 50 may be implemented in the ECU 14, for example as a data structure, programmed logic, or both, as more particularly described in detail below in connection with FIGS. 3-5. The ECT estimation model 50 finds particular application in the first embodiment of the invention, where the optional ambient temperature sensor 40 is provided on the vehicle. The predetermined start-up IAT data 52 may also be implemented in the ECU 14 as data structure, programmed logic, or a combination of both, as more particularly described in detail below in connection with FIGS. 6-7. The predetermined SUIAT threshold data 52 finds particular application in the second embodiment of the invention, where no ambient (soak) temperature reading is available (i.e., is an alternative approach for inferring when the engine block heater was operated during the previous soak).

As described in the Background, in extreme cold weather conditions, the engine block heater 16 may operated for heating up the engine coolant during long soak times. In this situation, the start-up engine coolant temperature will be hotter than the ambient temperature after an ample soak time. This induces a temperature offset between the start-up engine coolant temperature (SUECT) and the start-up intake air temperature (SUIAT). Table 1 shows exemplary temperature data (i.e., SUECT, SUIAT, dT) for a six hour soak time at −20° C. for various wind speeds where an engine block heater was used. Absent operation of the engine block heater, the SUECT should be close to ambient temperature, namely −20° C. after a six hour soak, but note that the measured SUECT values ranged between 1.6 and 30° C. Table 1 also shows that the temperature offset (dT) between the SUECT and the SUIAT, after ample soak time, was between 20.9 to 34.6° C., even though the IAT sensor was operating normally. The data in Table 1 shows how the effect the engine block heater has on the SUIAT and SUECT readings can erroneously indicate a skew problem.

TABLE 1

| Wind speed | Start-Up ECT | Start-Up IAT | |
|---|---|---|---|
| (mph) | (° C.) | (° C.) | dT (ECT − IAT) |
| 0 | 30 | 1 | 29 |
| 5 | 15.9 | −18.7 | 34.6 |
| 20 | 1.6 | −19.3 | 20.9 |

As also described in the Background, the conventional IAT diagnostic performs a secondary drift check on the IAT reading. Note, that for even 5 or 20 mph winds, the IAT is already very close to the ambient of −20° C. and hence would not able to change enough to meet the criteria of the secondary drift check (and avoid reporting a failed test). Thus, with an engine block heater, some situations cannot avoid producing an erroneous test failure (leading to a set DTC, lit MIL, etc.) even with the help of the secondary drift check.

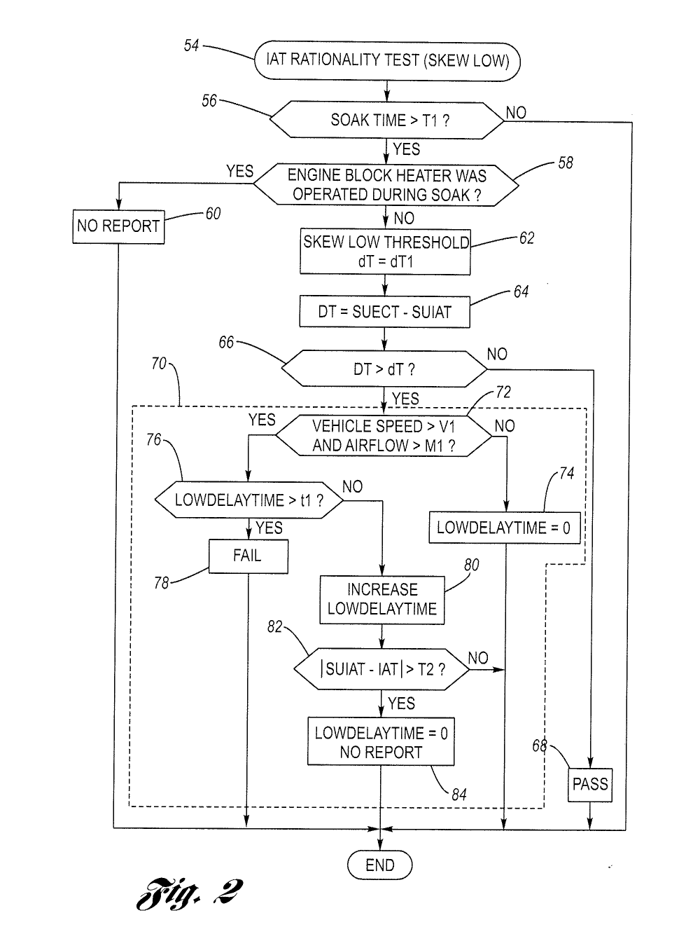

FIG. 2 is a flowchart diagram of a method of conducting an IAT rationality test for the first embodiment. The first embodiment makes use of the optional ambient (soak) temperature sensor 40 shown in FIG. 1. In this embodiment, the availability of the ambient temperature sensor 40 provides the information needed to utilize the minimum ECT estimation model 50. The model 50 is used for estimating a minimum start-up ECT (SUECT) if the engine block heater 16 was operated during the soak period. If the measured SUECT is equal to or greater than the estimated minimum start-up ECT, then the engine block heater 16 was operating during the soak period. Otherwise, the engine block heater 16 was operated during the soak period.

With continued reference to FIG. 2, the IAT rationality test 54 begins in step 56. The method is performed during start-up.

Step 56 involves determining whether vehicle soak conditions meet predetermined criteria for the test. In particular, the duration of the soak period must be longer than a predetermined time T1 (e.g., 6 hours). The duration is a calibrated value, but in general must be long enough to ensure that the vehicle, including the engine block, coolant, etc., has reached thermal equilibrium. If the soak period has not been long enough, then the method ends. This is due to an insufficient soak time to allow for thermal equilibrium to be reached, and hence any assumption about SUIAT and SUECT being the same would be unwarranted. If the answer in step 56 is YES, then the method proceeds to step (decision block) 58.

In step 58, the ECU 14 determines whether the engine block heater 16 was operated during the soak period. While this step will be described in greater detail below, if the answer in step 58 is YES, then the method will proceed to step 60, in which “no report” concerning whether the test passed or failed would be made to the diagnostic data manager or other diagnostic service. This is because any conclusion, particularly a “test failed” report, is inherently ambiguous and hence unreliable since any observed skew could be the result of either a faulty IAT sensor/circuit, on the one hand, or could alternatively be the result of the engine block heater be operated, on the other hand. If the answer in step 58 is NO, then the method will proceed to step 62. In this section of the method, it has been determined that the engine block heater 16 was not operated, and therefore any observed IAT skew (skew low) can be reliably assumed to be the result of a truly faulty IAT sensor/circuit.

In step 62, a skew threshold (dT) is set, which for example may be 20° C., corresponding to the minimum amount of IAT skew. In step 64, the ECU 14 determines the difference (DT) between the start-up ECT (SUECT) and the start-up IAT (SUIAT). Start-up means the time the engine ignition is turned on (key on). In step 66, the ECU 14 determines whether the determined difference (DT) is greater than the skew threshold (dT). In the answer in step 66 is NO, then the method branches to step 68, where the ECU 14 generates a pass indication for the IAT rationality test (skew low), and thereafter the method ends. This result simply means that the measured difference, if any, was not great enough to be considered skewed to the low side for purposes of the IAT rationality test (skew low). However, if the difference (DT) is greater than the skew threshold (dT), further inquiry is warranted, and the method is configured to perform a secondary IAT drift check, enclosed by the dashed-line box 70 in FIG. 2. As described above, the secondary check 70 is performed to determine whether the observed temperature offset is due to a skewed IAT sensor/circuit, or whether it is due to non-stabilized ambient conditions. U.S. Pat. No. 7,120,535 entitled “METHOD AND APPARATUS TO EVALUATE AN INTAKE AIR TEMPERATURE MONITORING CIRCUIT” issued to Rahman et al., for example, describe such a secondary drift check, which is hereby incorporated by reference in its entirety for such purpose. The secondary check 70 begins with step (decision block) 72.

In step 72, the ECU 14 determines whether the vehicle speed is higher than a speed threshold (V1) and whether the air mass flow rate is higher than an airflow threshold (M1). If the answer in step 72 is NO, the method branches to step 74 where a timer (LowDelayTime) is reset to zero. The logic in step 72 requires that the vehicle be moving and that the engine 12 be moving adequate mass airflow there through in order to observe a change in the IAT reading. If the answer in step 72 is YES, then the method branches to step (decision block) 76.

In step 76, the ECU 14 determines whether the timer (LowDelayTime) has exceeded the timer threshold (t1). If YES, then that means that the measured IAT has not changed sufficiently (more on this below) and the method branches to step 78. In step 78, the ECU 14 generates a fail indication and reports the same to the diagnostic data manager or other service, all in the manner described above. Otherwise, if the timer (LowDelayTime) has not reached the timer threshold (t1) (i.e., the answer in step 76 is NO), then the method branches to step 80.

In step 80, the ECU 14 increments the timer (LowDelayTime), and proceeds to step (decision block) 82, where the ECU 14 determines whether the present IAT reading has changed from the start-up IAT (SUIAT), in absolute value terms, by more than a predetermined drift threshold (e.g., 10° C.). If the answer in step is NO, then the method branches to the end of the IAT rationality test.

If the answer in step 82 is YES, however, then the method proceeds to step 84, where the timer (LowDelayTime) is reset to zero, and the IAT rationality test 54 is discontinued with “No Report” being made to the diagnostic data manager or other service as to either “Pass” or “Fail”. Through this construct, the secondary drift check 70, through repeated looping at periodic times, will allow for a series of checks to be made, while the timer is incrementing, to see whether the measured IAT has changed enough from the start-up IAT to warrant the conclusion that it is operating properly.

FIG. 3 is a diagrammatic view of a the minimum start-up ECT estimation thermal model 50′. The model 50′ depicts in block form for understanding the electronic version of the model 50 deployed in the ECU 14. The model is configured to estimate the minimum temperature value (T_{coolon}) of the start-up engine coolant temperature (ECT) if the engine block heater 16 has been operated during the soak period. Equation (1) below sets forth the relationship:

T_{coolon}=(a*(T_{cooloff}−T_{soakoff})+qₕₑₐₜₑᵣ)/tₛₒₐₖ+Tₛₒₐₖₒₙ (1)

Where a=h_{cooloff}/h_{coolon},

T_{soakoff}: Ambient temperature before soaking [° K.],

Tₛₒₐₖₒₙ: Ambient temperature after soaking [° K.],

T_{cooloff}: Coolant temperature before soaking [° K.],

T_{coolon}: Coolant temperature after soaking [° K],

h_{coolon}: Heat Transfer Coefficient before soak [W/m²° K.],

h_{cooloff}: Heat Transfer Coefficient after soak [W/m²° K.],

qₕₑₐₜₑᵣ: Engine block heater work [W], and

tₛₒₐₖ: Soaking time [Hr].

It should be understood that the foregoing parameters can all be characterized with knowledge of the particular engine 12 (i.e., its configuration), the particulars of the engine block heater 16 used, etc. Implementing model 50, in view of the enabling disclosure herein, would take no more than routine application of ordinary skill in the art.

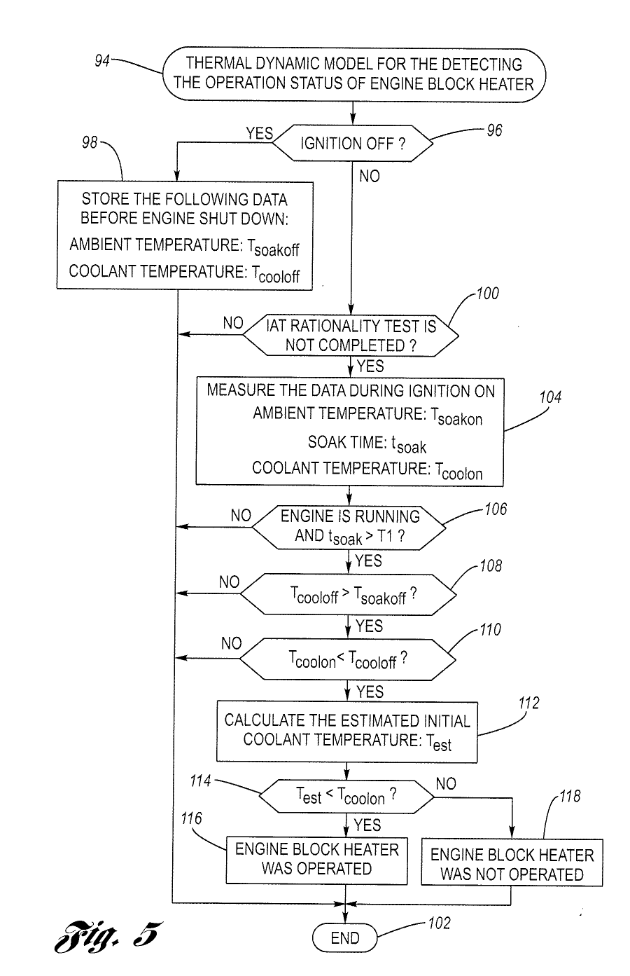

FIGS. 4A-4B are charts showing the results of using the minimum start-up estimated ECT model 50. FIGS. 4A-4B specifically show actual test measurements of the engine coolant temperature, with and without the engine block heater being operated, when soaked at an ambient temperature of −20° C. (@ two different wind speeds). FIG. 4A shows the test results when the wind speed was established at 20 mph. The trace 86 represents the minimum ECT value obtained from the model 50 described in equation (1). As shown, with the engine block heater 16 on, the start-up ECT (enclosed by box 88) is near zero degrees. With the engine block heater 16 off, the ECT (enclosed by box 90) is near −20° C. (i.e., near the ambient soak temperature). Note that trace 86 represent the minimum SUECT, and while the increased wind speed reduces the SUECT for the “engine block heater on” situation, trace 86 nonetheless provides a meaningful delineation between “heater on” (above trace 86) and “heater off” (below trace 86) situations.

FIG. 4B shows the same soak conditions, except that the wind speed has been reduced to 5 mph. With the engine block heater 16 on, the start-up ECT after ample soak time (enclosed by box 92) is between 10° C. and 20° C. Again, the trace 86 provides a meaningful delineation between “heater on” (points above trace 86) and “heater off” (points below trace 86) situations.

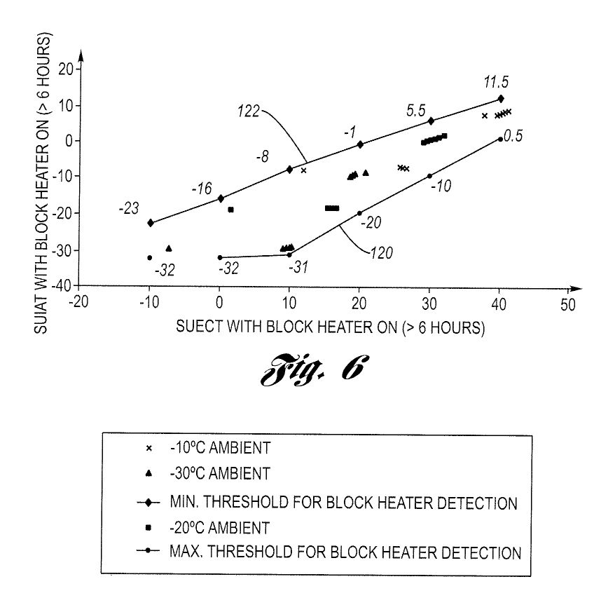

FIG. 5 is a flowchart showing, in greater detail, the step 58 of FIG. 2 (i.e., the step of determining whether the engine block heater was operated during the soak period). As described above, in the first embodiment, a thermal dynamic model is used, and is represented by the block 50 in FIG. 1 (accessible by the logic programmed in the ECU 14). The method begins in step 96.

In step 96, the ECU 14 determines whether the vehicle “ignition” is off. Ignition off is conventionally understood to mean that the operator of the vehicle has turned the ignition key to the off position. The ECU 14, in response, attends to a variety of matters before actually shutting down the engine, including items to be described in connection with this FIG. 5. If the answer in step 96 is YES, then the method proceeds to step 98.

In step 98, the ECU 14 is configured to read and store the ambient temperature T_{soakoff} and the engine coolant temperature T_{cooloff}. These values, as described above, will be needed after the soak period ends, during start-up, to calculate (using model 50) the minimum start-up ECT value if the engine block heater was used during soak. The method then proceeds to the end (step 102).

Returning to step 96, if the answer is NO, then the method branches to step (decision block) 100. In step 100, if the IAT rationality test (FIG. 2) is complete, then the method branches to the end (step 102). Otherwise, if the IAT rationality test is incomplete (ongoing), then the method proceeds to step 104.

In step 104, the ECU 14 measures, during start-up (Ignition On), the values of various parameters needed to evaluate equation (1), namely, the ambient temperature Tₛₒₐₖₒₙ, the duration of the soak period tₛₒₐₖ, and the start-up engine coolant temperature T_{coolon}. The method proceeds to steps 106, 108 and 110, which collectively define various boundary conditions which must be satisfied to use the model 50.

In step 106, the ECU 14 determines whether the engine is running and the duration of the soak period (tₛₒₐₖ) is greater than the soak time threshold (T1; e.g., 6 hours). If the answer is NO, then the method ends (step 102). Otherwise, the method proceeds to step 108.

In step 108, the ECU 14 determines whether the ECT at engine shutdown is greater than the ambient temperature on ignition off. If the answer is NO, then the method ends (step 102). This check is to ensure that the ambient temperature (on ignition off/shutdown) is lower and will be able to drive down the engine coolant temperature during soak. Otherwise, the method proceeds to step 110.

In step 110, the ECU 14 determines whether the ECT (on start-up) is less than the ECT (on ignition off). Again, a needed logical check. If NO, then the method ends (step 102). Otherwise, the method proceeds to step 112.

In step 112, the ECU 14 determines, through the use of the model 50, the estimated minimum start-up (initial) ECT, which the ECU 14 then compares against the measured start-up ECT in step 114. If the measured start-up ECT is greater than the estimated minimum ECT (YES), then the method branches to step 116, where a logical flag or some other comparable mechanism is used to indicate that the engine block heater 16 was operated during the soak period. However, if the measured start-up ECT is not greater than the estimated minimum ECT (NO), then the method branches to step 118, where a logical flag or some other comparable mechanism is used to indicate that the engine block heater 16 was NOT operated during the soak period. In both cases, the method ends (step 102).

In sum, in the first embodiment (FIGS. 2 and 5), when the logic determines that the engine block heater 16 was operated during the soak period, then the logic of the IAT rationality test does not report the results of the test to the diagnostics manager. As described above, this prevents erroneous test failures from being reported.

Some vehicle models do not have an ambient (soak) temperature sensor 40, and use only the IAT sensor 32 for air flow calculations and the like. Accordingly a second embodiment of the invention will be described in connection with FIGS. 6-7 that does not require an ambient (soak) temperature sensor/reading.

FIG. 6 is a chart showing start-up IAT data as a function of start-up ECT values, particularly illustrating minimum and maximum start-up IAT thresholds. Over a large number of cool-down tests, it was observed that the data collected defined a specific window in which IAT values indicate that the engine block heater 16 was operated during the soak period. This was evident even over different winds speeds (e.g., 0 mph and 30 mph air speeds were used). Such a window is bounded by a trace 120 corresponding to a minimum start-up IAT threshold and a trace 122 corresponding to a maximum start-up IAT threshold. The method will first use the measured start-up ECT to identify corresponding minimum and maximum start-up IAT thresholds. Again, values between the minimum and maximum are indicative of the potential use of the engine block heater. Then, the method will see whether the measured start-up IAT falls between the minimum and maximum IAT thresholds. If so, then operation of the engine block heater 16 during the second period can be inferred.

First, the method determines whether the following predicate conditions are met: (1) the difference between the start-up ECT and the start-up IAT being greater than a first temperature threshold (i.e., T1 in FIG. 7), for example 20° C.; AND (2) the start-up ECT being between a second temperature threshold (i.e., T2 in FIG. 7), for example 10° C., and a third temperature threshold (i.e., T3 in FIG. 7), for example 40° C.; AND (3) the start-up IAT being less than a fourth temperature threshold (i.e., T4 in FIG. 7), for example 0° C.

The method then identifies a range of IAT values based on the measured start-up ECT (i.e., using the data structure 52 in FIG. 1, corresponding to the traces 120, 122 in FIG. 6). The method then compares the measured start-up IAT to see if it is within the identified range (i.e., between the maximum and minimum IAT thresholds). If the measured start-up IAT is below the minimum start-up IAT threshold, then no block heater was operated and the diagnostic will fail. Otherwise, if the measured start-up IAT is above the maximum start-up IAT threshold, then no block heater was operated and the currently implemented skew test will run. Finally, if the start-up IAT is in the range (i.e., between the maximum and minimum start-up IAT thresholds), then the engine block heater was operated and the method will not report any results from the present diagnostic cycle to the diagnostic data manager or other service. With this overview, a detailed description of the method in FIG. 7 will now be set forth.

FIG. 7 is a flowchart showing, for the second embodiment, a method 124 for conducting an IAT rationality test having engine block heater operation detect feature. The method begins in step 126.

In step 126, the ECU 14 determines whether the IAT (skew low) rationality test is enabled. In this regard, block 128 describes some of the criteria, including whether any related component errors have already been detected (in which case the diagnostic 124 would not be enabled), whether the duration of the soak period exceeds a predetermined minimum time (e.g., H hours, typically at least 6 hours—a calibrated value), and whether the start-up ECT is greater than an initial temperature threshold (T0), for example −20° C.

If the answer in step 126 is YES, then the method branches to step (decision block) 130. Otherwise, the method ends (step 140).

Steps 130, 132 and 134 are the predicate condition checks described above. If these checks are satisfied, then a specific check is required to determine whether the engine block heater 16 was operated during the soak period, as indicated in block 136 (i.e., block heater detection request is TRUE). Otherwise, if the temperature difference between the start-up ECT and the start-up IAT is less than the first temperature threshold, then the method branches to step 138, where the diagnostic method generates a “test pass” indication, and then ends (step 140). Likewise, if the temperature difference exceeds the first temperature threshold (step 130), but one of the conditions in steps 132 or 134 are not met, then there will be no need for an engine block heater detection request, as indicated in blocks 142 and 144 (i.e., block heater detection request is FALSE). From both blocks 142 and 144, the method feeds into the secondary drift check 70, which is the same as described above in connection with FIG. 2 and accordingly will not be described here for FIG. 7. Again, the secondary check 70 will determine whether there is a real IAT sensor/circuit skew or whether non-stabilized ambient conditions led to the IAT reading skew. In any event, when the predicate conditions are satisfied (i.e., steps 126, 130, 132, and 134), the method proceeds through to step (decision block) 146.

In step 146, overall, the ECU 14 determines whether the measured start-up IAT is within the start-up IAT “window”, which would indicate that the engine block heater 16 was operated during the previous soak period. To do this, the ECU 14 first determines the minimum start-up IAT using the start-up IAT maximum/minimum data structure 52 (FIG. 1) based on the measured start-up ECT (SUECT). That is, the measured SUECT will intersect the trace 120 (minimum threshold) in FIG. 6, thus defining the minimum SUIAT threshold. Likewise, the ECU 14 will do the same to obtain the maximum SUIAT threshold. Once the minimum and maximum thresholds are determined, they collectively define a range or “window”. If the measured SUIAT is between these thresholds (i.e., within the “window”), then the method will conclude that the engine block heater was operated during the soak period, as indicated in step 148 (i.e., block heater detected is TRUE). Accordingly, the IAT rationality test (skew low) will be immediately discontinued and no report as to the results of the diagnostic will be sent to the diagnostic data manager (step 150). The method then ends (step 140).

However, if the SUIAT is not within the “window”, then the method concludes that the engine block heater 16 was not used during the soak period, as indicated in step 152 (i.e., block heater detected is FALSE). The method proceeds to step 154.

In step 154, the ECU 14 implements the remainder of the logic described above. Specifically, if the SUIAT is greater than the maximum SUIAT threshold (i.e., the answer in step 154 is “NO”), then the currently implemented skew test will run (i.e., the block heater detection method ends—step 140). However, if the SUIAT is less than the minimum SUIAT threshold (i.e., the answer in step 154 is “YES”), then the method proceeds to steps 156 and 158. In step 156, a fail counter (FCN) is incremented, and is then checked in step 158 against a predetermined fail counter threshold (C1). If the fail counter (FCN) is greater than or equal to the fail counter threshold, then the method will proceed to step 160, where a fail indication will be generated. For example, the fail counter FCN may need to reach 10 counts (where 1 count is 125 ms) to equal the fail counter threshold.

In sum, the invention reduces or eliminates false failure reports for the IAT rationality (low skew) test in an automotive vehicle of the type having an engine block heater. In a first embodiment that is suitable for use in vehicles having an ambient (soak) temperature sensor, a minimum start-up engine coolant temperature (ECT) estimation model (thermal dynamic) is configured to estimate a value of the minimum start-up ECT if the engine block heater was operated during soak, as described above. The measured start-up ECT is then compared with the estimated minimum ECT from the model, and if it is higher, then the logic concludes that the engine block heater was operated during the soak period. The IAT rationality test diagnostic is then configured to forego reporting any test results. In a second embodiment that is suitable for use in vehicles without an ambient (soak) temperature sensor, an alternative approach is presented for determining whether an engine block heater was operated during soak. This alternative approach examines a range of start-up IAT values based on minimum and maximum IAT thresholds selected based on the start-up ECT value. The approach then assesses the measured start-up IAT to see if it falls within this range. If so, then the engine block heater was operated during the soak period, and again, reporting is disabled to prevent erroneously set DTCs.

It should be understood that the ECU 14 as described above may include conventional processing apparatus known in the art, capable of executing pre-programmed instructions stored in an associated memory, all performing in accordance with the functionality described herein. That is, it is contemplated that the processes described herein will be programmed in a preferred embodiment, with the resulting software code being stored in the associated memory. Implementation of the invention, in software, in view of the foregoing enabling description, would require no more than routine application of programming skills by one of ordinary skill in the art. Such an ECU may further be of the type having both ROM, RAM, a combination of non-volatile and volatile (modifiable) memory so that the software can be stored and yet allow storage and processing of dynamically produced data and/or signals.

While particular embodiments of the invention have been shown and described, numerous variations and alternate embodiments will occur to those skilled in the art. Accordingly, it is intended that the invention be limited only in terms of the appended claims.

1. A method of conducting an intake air temperature (IAT) rationality test in a vehicle with an engine having an engine block heater, said method comprising the steps of:
determining that vehicle soak conditions meet predetermined criteria for the test, including a duration of a soak period and commencing the test at a start-up time; and
determining whether the engine block heater was operated during the soak period; and
discontinuing the rationality test when the engine block heater has been determined to have been operated during the soak period.

2. The method of claim 1 further including the steps of:
determining that the engine block heater was not used during the soak period; and
thereafter assessing a temperature difference between a start-up engine coolant temperature (ECT) and a start-up IAT each taken at the start-up time.

3. The method of claim 2 wherein said assessing step includes the substeps of:
establishing a first temperature threshold corresponding to a minimum IAT skew level;
generating a pass indication with respect to the IAT rationality test when the temperature difference is less than or equal to the first temperature threshold.

4. The method of claim 2 wherein said assessing step includes the substeps of:
establishing a first temperature threshold corresponding to a minimum IAT skew level;
initiating a secondary drift check when the temperature difference is greater than the first temperature threshold wherein the secondary drift check comprises the substep of:
generating a fail indication when an absolute difference between a monitored IAT taken during the secondary drift check and the start-up IAT does not exceed a drift threshold prior to the expiration of a predetermined time;
discontinuing the secondary drift check when the absolute difference exceeds the drift threshold prior to the expiration of the predetermined time.

5. The method of claim 1 wherein said step of discontinuing the IAT rationality test is performed without report as to the result of such test.

6. The method of claim 1 wherein said step of determining whether the engine block heater was operated during the soak period includes the substep of:
verifying that boundary conditions for use of an ECT estimation model are satisfied.

7. The method of claim 6 wherein said step of determining whether the engine block heater was used during the soak period includes the substeps of:
estimating a minimum engine coolant temperature (ECT) at the start-up time in accordance with the ECT estimation model; and
determining that the engine block heater was operated during the soak period when the start-up ECT exceeds the estimated minimum ECT from the model.

8. The method of claim 7 further including the step of:
determining that the engine block heater was not operated during the soak period when the start-up ECT is equal to or less than the estimated minimum ECT from the model.

9. The method of claim 7 wherein said estimating substep includes:
measuring a start-up ambient temperature at the start-up time; and
evaluating the ECT estimation model using stored ambient temperature and engine coolant temperatures both taken before the soak period, the start-up ECT, the start-up ambient temperature and the duration of the soak period.

10. The method of claim 2 wherein said step of determining whether the engine block heater was operated during the soak period includes the substep of:
verifying that predicate conditions are satisfied wherein the conditions include (1) the temperature difference between start-up ECT and IAT exceeding a first temperature threshold corresponding to a minimum IAT skew level; (2) the start-up ECT being within a range between a second temperature threshold and a third temperature threshold; and (3) the start-up IAT being less than a fourth temperature threshold.

11. The method of claim 10 wherein said step of determining whether the engine block heater was operated during the soak period includes the substeps of:
determining respective minimum and maximum start-up IAT (SUIAT) thresholds using predetermined SUIAT data as a function of the start-up ECT (SUECT); and
determining that the engine block heater was operated during the soak period when the start-up IAT is between the minimum and maximum SUIAT thresholds.

12. The method of claim 10 wherein said step of determining whether the engine block heater was operated during the soak period includes the substeps of:
determining respective minimum and maximum start-up IAT (SUIAT) thresholds using predetermined SUIAT data as a function of the start-up ECT (SUECT); and
generating a fail indication when the SUIAT is less than the minimum SUIAT threshold.

13. The method of claim 10 wherein said step of determining whether the engine block heater was operated during the soak period includes the substeps of:
determining respective minimum and maximum start-up IAT (SUIAT) thresholds using predetermined SUIAT data as a function of the start-up ECT (SUECT); and
determining that the engine block heater was not operated during the soak period when the SUIAT is greater than the maximum SUIAT threshold.

14. In a vehicle having an engine with an engine block heater, a method of determining whether the engine block heater was operated during a soak period, comprising the steps of:
verifying that boundary conditions for use of an ECT estimation model are satisfied.
estimating a minimum engine coolant temperature (ECT) at a start-up time in accordance with the ECT estimation model; and
determining whether the engine block heater was operated during the soak period based on a comparison of a start-up ECT and the estimated minimum ECT from the model.

15. The method of claim 14 wherein said determining step includes the sub-step of:
determining that the engine block heater was operated during the soak period when the start-up ECT is greater than the estimated minimum ECT from the model.

16. The method of claim 14 wherein said determining step includes the sub-step of:
determining that the engine block heater was not operated during the soak period when the start-up ECT is equal to or less than the estimated minimum ECT from the model.

17. The method of claim 14 wherein said estimating step includes the sub-steps of:
measuring a start-up ambient temperature at the start-up time; and
evaluating the ECT estimation model using stored ambient temperature and engine coolant temperatures both taken before the soak period, the start-up ECT, the start-up ambient temperature and a duration of the soak period.

18. In a vehicle having an engine with an engine block heater, a method of determining whether the engine block heater was operated during a soak period, comprising the steps of:
verifying that predetermined predicate conditions based on a start-up engine coolant temperature (SUECT) and a start-up intake air temperature (SUIAT) are satisfied wherein the SUECT and SUIAT are taken after the soak period upon start-up of the engine;
determining respective minimum and maximum SUIAT thresholds using predetermined SUIAT data as a function of the SUECT; and
determining whether the engine block heater was operated during the soak period based on a comparison of the SUIAT and the minimum and maximum SUIAT thresholds.

19. The method of claim 18 wherein the conditions include (1) the temperature difference between the SUECT and the SUIAT exceeding a first temperature threshold corresponding to a minimum IAT skew level; (2) the SUECT being within a range between a second temperature threshold and a third temperature threshold; and (3) the SUIAT being less than a fourth temperature threshold.

20. The method of claim 18 wherein said step of determining whether the engine block heater was operated includes the sub-step of:
determining that the engine block heater was operated during the soak period when the SUIAT is between the minimum and maximum SUIAT thresholds.

21. The method of claim 18 wherein said step of determining whether the engine block heater was operated includes the sub-step of:
determining that the engine block heater was not operated during the soak period when the SUIAT is greater than the maximum SUIAT threshold or less than the minimum SUIAT threshold.
